(19) United States
(12) Patent Application Publication
(10) Pub. No.: US 2026/0322898 A1
(43) Pub. Date: Oct. 15, 2026

(54) Privacy Phone System

(71) Applicant: Nelson Arvelo, Newark, NJ (US)

(72) Inventor: Nelson Arvelo, Newark, NJ (US)

(21) Appl. No.: 19/411,498

(22) Filed: Dec. 8, 2025

Related U.S. Application Data
(60) Provisional application No. 63/787,033, filed on Apr. 11, 2025.

(51) Int. Cl. H04M 1/02; G10K 11/162

(52) U.S. Cl. CPC H04M 1/0203; G10K 11/162

(57) ABSTRACT

A privacy phone case device that provides voice privacy during phone conversations in public environments is disclosed. The device includes a main case body configured to removably attach to a smartphone and a privacy or audio barrier extendable from at least one lateral end of the case. The barrier is designed as an accordion-style extension that forms a curved acoustic chamber to muffle the user's voice and reduce sound leakage or sound bleed. In additional embodiments, the device includes a multilayer structure with an outer shell made of rubberized plastic and an inner shell comprised of acoustic foam for sound dampening. In one embodiment, a wearable privacy mask is also described, incorporating a microphone and wireless communication module for hands-free, private conversations. A selectively detachable latch-on case version is further disclosed, which includes a compact, modular attachment optionally equipped with a fold-out acoustic shield.

### CROSS-REFERENCE TO RELATED APPLICATION

The present application claims priority to, and the benefit of, U.S. Provisional Application No. 63/787,033 which was filed on Apr. 11, 2025 and is incorporated herein by reference in its entirety.

### FIELD OF THE INVENTION

The present invention generally relates to mobile communication accessories and privacy enhancement systems. More specifically, the present invention relates to a privacy phone (i.e., smartphone) case device configured to muffle outgoing voice signals and block ambient noise during mobile phone use in public environments. The invention comprises a main case body configured to removably attach to a smartphone, and an integrated or attachable privacy or audio barrier extendable from a lateral edge of the case. In one embodiment, the privacy or audio barrier is constructed as an accordion-style shield that deploys into a curved, semi-cylindrical acoustic chamber covering the user's mouth and microphone pickup zone. The barrier includes a multilayer structure with an acoustic foam inner shell and a rigid outer shell for structural support. Additional embodiments include a selectively detachable latch-on case and a wireless privacy mask with built-in microphone and wireless communication protocol. The system is designed to protect user speech privacy, minimize voice leakage, and enhance communication discretion in public or shared spaces. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals are often required to make or receive phone calls in public environments such as airports, cafés, public transportation, offices, or waiting areas. While mobile communication offers convenience, it also raises significant concerns related to the privacy of spoken conversations, particularly when sensitive or confidential information is involved.

Many users discuss personal or professional matters in public, often with no means of shielding their voice or the audio emitted from their phone's speakers. The lack of privacy can result in the accidental disclosure of private information, such as credit card numbers, home addresses, medical details, passwords, or other confidential data. Individuals may be unaware that their voices carry beyond their intended listener, especially in crowded or acoustically reflective environments.

Despite the growing awareness of digital data privacy, there remains a gap in physical, voice-based privacy solutions for mobile communication. Traditional phone cases and accessories offer device protection but do not address the risk of verbal information leakage. As a result, there exists a need for a device that provides discreet, effective acoustic shielding during mobile phone calls.

Therefore, there exists a long-felt and unresolved need in the art for a privacy solution that enables individuals to maintain voice confidentiality during mobile phone conversations in public settings. There is a long-standing need for a device that can effectively muffle the user's voice, block external noise, and prevent accidental disclosure of sensitive personal or business information. Further, there is a need in the art for a privacy case device that integrates seamlessly with a user's existing smartphone without requiring additional gadgets or software. Additionally, there is a need for a phone case device that features multiple versions that can latch onto the phone, extend from the phone, and/or pair with a mask. Finally, there exists a need for a privacy phone case system with extendable and wearable barriers designed specifically to muffle outgoing speech, block ambient noise, and enhance the privacy and clarity of voice communication in public settings.

The subject matter disclosed and claimed herein, in one embodiment, comprises a privacy phone case device that includes a main case body and a deployable privacy or audio barrier. The main case body is shaped to contour the rear and lateral dimensions of a smartphone and provides both physical protection and a structural foundation for the privacy components. The privacy or audio barrier is housed within or along at least one lateral edge of the case and is deployable in an accordion-style configuration. When extended, the barrier forms a curved acoustic chamber that surrounds the user's mouth and ear. In this extended position, the privacy or audio barrier is capable of muffling the user's voice while also reducing the intrusion of ambient sound, thereby improving call clarity and speech privacy.

In one embodiment, the privacy or audio barrier comprises a multilayer construction including an outer shell and an inner acoustic lining. The outer shell provides structural rigidity using materials such as rubberized plastic or carbon fiber-textured polymers. The inner shell is comprised of sound-dampening materials such as neoprene or acoustic foam, which absorb and suppress vocal leakage. In another embodiment, the invention includes a wireless privacy mask device configured to be worn over the user's mouth region. The mask is held in place with ergonomic support straps and contains a built-in microphone.

In this manner, the privacy phone case system and associated devices of the present invention address longstanding deficiencies in the art by introducing a versatile, sound-insulating device that enables private communication without sacrificing mobile functionality. The system can be implemented as a case-integrated extendable barrier, a selectively detachable latch-on unit, and/or a wireless wearable mask. Further, the system enables users to hold private conversations discreetly in public environments. The system reduces the risk of sensitive information being overheard by muffling outgoing speech, blocking ambient sound, and improving sound clarity. The combination of practical structure, acoustic materials, and modular deployment mechanisms offers a user-friendly solution to the privacy challenge of smartphone users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a privacy phone case device provided for use with a smartphone. The device includes a main case body that is removably adhered or affixed to the rear surface of the smartphone. This main case body is contoured to match, or conform to, the outer dimensions of the smartphone and is configured to offer mechanical support and shock protection. A privacy or audio barrier is attached to at least one lateral end of the main case body and is designed as an accordion-style extension barrier. The privacy or audio barrier is foldable (i.e., retractable) and extendable from the main case body and, in its extended configuration (i.e., deployed position), forms a curved acoustic chamber that covers the mouth area of the user and the microphone pickup zone of the smartphone. When not in use, the privacy or audio barrier collapses neatly into the lateral end of the main case body for portability.

In another embodiment, a privacy or audio barrier device is disclosed for integration with a phone case. The device comprises an outer shell that has an accordion-style structure, and the outer shell is formed from rubberized plastic or carbon fiber-textured polymer to provide both flexibility and structural integrity. An inner shell is bonded to the outer shell and is made from acoustic foam or neoprene, which is adapted to absorb and dampen the user's voice during use. The privacy or audio barrier is configured to extend from the lateral end of the main case body of the phone case and, in the extended position, forms a curved acoustic chamber around the user's face extending from the ear to the mouth region.

In one embodiment, a wearable privacy device is provided in the form of a privacy mask. The privacy mask is designed to be positioned over the mouth region of a user and is held in place using one or more support straps that extend around the ears of the user. A microphone is integrated into the internal cavity of the mask and is configured to capture the user's speech while significantly minimizing the leakage of sound into the surrounding environment. The mask further pairs with a mobile device and transmits voice data using a wireless protocol such as Bluetooth, Wi-Fi, or other low-energy standards.

In yet another embodiment, a selectively detachable latch-on case device is disclosed for use with a mobile phone. The device comprises a modular attachment that is configured to latch securely onto the lower and side edges of the mobile phone. It is specifically designed to avoid interference with the phone's screen, ports, or physical buttons. The latch-on device features a compact structure that enables it to be easily removed or reattached, offering convenience and flexibility in usage. In certain embodiments, the latch-on case may include fold-out or snap-on acoustic shells that deploy to surround the user's mouth region, thereby forming a temporary acoustic barrier to enhance voice privacy.

In still another embodiment, a privacy phone case system is provided and comprises a smartphone, a main case body, and a privacy or audio barrier. The main case body is removably attached to the rear panel of the smartphone and is contoured to expose functional elements such as the upper rear camera area while preserving the slim profile of the device. The main case body offers both mechanical support and shock protection and includes a lateral end from which a multilayer privacy or audio barrier extends. The privacy or audio barrier includes an outer shell and an inner shell and is configured to deploy into a semi-cylindrical configuration that covers the speaker's mouth and reduces sound leakage or sound bleed. The inner shell provides acoustic insulation, while the outer shell supports the structural shape of the barrier, enabling discreet and effective voice privacy during phone conversations.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a smartphone partially encased in a privacy phone case device of the present invention in accordance with the disclosed structure;

FIG. 2 shows a rear perspective view of the smartphone partially encased within the main body of the private call privacy case of the present invention in accordance with the disclosed structure;

FIG. 3 illustrates a cross-sectional view of the privacy or audio barrier used in the privacy phone case device of FIG. 1 in accordance with the disclosed structure;

FIG. 4 illustrates a perspective view of a privacy phone case with the privacy or audio barrier in the extended configuration (i.e., deployed position) during use in accordance with the disclosed structure;

FIG. 5 illustrates a perspective view of a user engaged in a phone call while using the privacy mask device of FIG. 1 in accordance with the disclosed structure;

FIG. 6 illustrates a user wearing another embodiment of the privacy device of the present invention in the form of a wireless privacy mask in accordance with the disclosed structure; and

FIG. 7 illustrates a front view of the smartphone fitted with another embodiment of the privacy device in the form of a selectively detachable latch-on case device in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt and unresolved need in the art for a privacy solution that enables individuals to maintain voice confidentiality during mobile phone conversations in public settings. There is a long-standing need for a device that can effectively muffle the user's voice, block external noise, and prevent accidental disclosure of sensitive personal or business information. Further, there is a need in the art for a privacy case device that integrates seamlessly with a user's existing smartphone without requiring additional gadgets or software. Additionally, there is a need for a phone case device that features multiple versions that can latch onto the phone, extend from the phone, pair with a mask. Finally, there exists a need for a privacy phone case system with extendable and wearable barriers designed specifically to muffle outgoing speech, block ambient noise, and enhance the privacy and clarity of voice communication in public settings.

The present invention, in one exemplary embodiment, is a wearable privacy device is in the form of a privacy mask. The privacy mask is designed to be positioned over the mouth region of a user and is held in place using one or more support straps that extend around the ears of the user. A microphone is integrated into the internal cavity of the mask and is configured to capture the user's speech while significantly minimizing the leakage of sound into the surrounding environment. The mask further pairs with a mobile device and transmits voice data using a wireless protocol such as Bluetooth, Wi-Fi, or other low-energy standards.

Reference will now be made in detail to the present preferred embodiments of the invention, examples of which are illustrated in the accompanying drawings. Wherever possible, the same reference numerals are used in the drawings and the description to refer to the same or like parts.

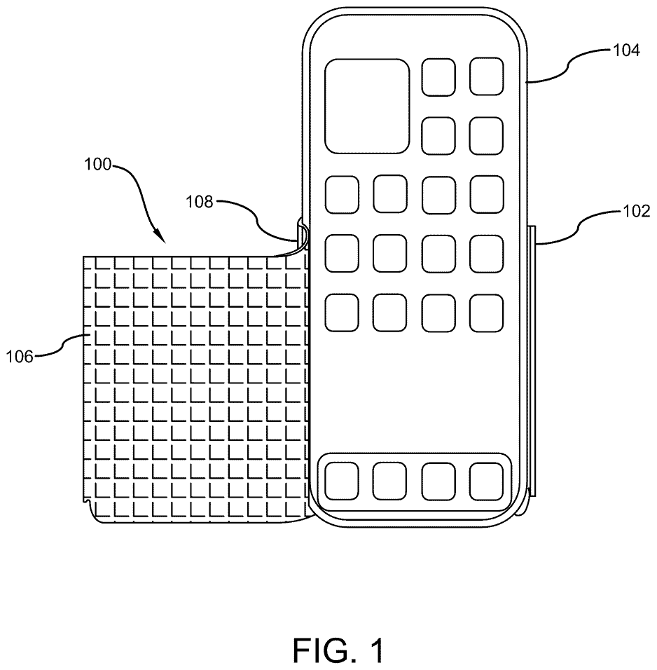

Referring initially to the drawings, FIG. 1 illustrates a perspective view of a smartphone partially encased in a privacy phone case device of the present invention in accordance with the disclosed structure. The privacy phone case device 100 of the present invention is designed as a phone case system to provide voice privacy during phone conversations in public settings. The privacy phone case device 100 prevents individuals nearby from overhearing sensitive or personal details and focuses and amplifies audio from the phone speaker to the user's ear. More specifically, the privacy phone case device 100 of the present embodiment includes a main case body 102 which is generally rectangular (i.e., rectilinear) to contour, or align with, the outer dimensions of a standard smartphone or other similar communication devices. The main case body 102 is removably adhered or affixed to the rear surface of the smartphone 104, provides enhanced physical protection to the smartphone 104, and serves as the base structure for mounting the privacy or audio barrier offered by the privacy phone case device 100.

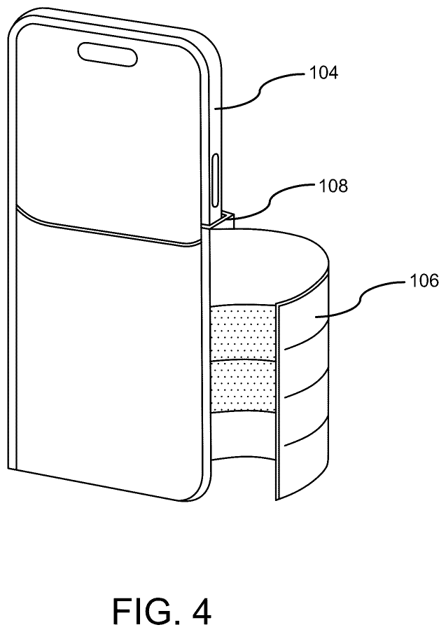

A privacy or audio barrier 106 is designed as an accordion-style extension barrier and is designed to fold laterally from at least one lateral end 108 of the main case body 102. The privacy or audio barrier 106 in an extended configuration (i.e., deployed position) is designed to form a curved, semi-cylindrical acoustic chamber around the user's face (i.e., from ear to mouth) such as illustrated in FIG. 4. The privacy or audio barrier 106 in the collapsed or non-deployed position, flushes or folds into the lateral end 108 of the main case body 102 for portability. When in use, the barrier covers the mouth area and the microphone pickup zone, muffling the user's voice to prevent eavesdropping.

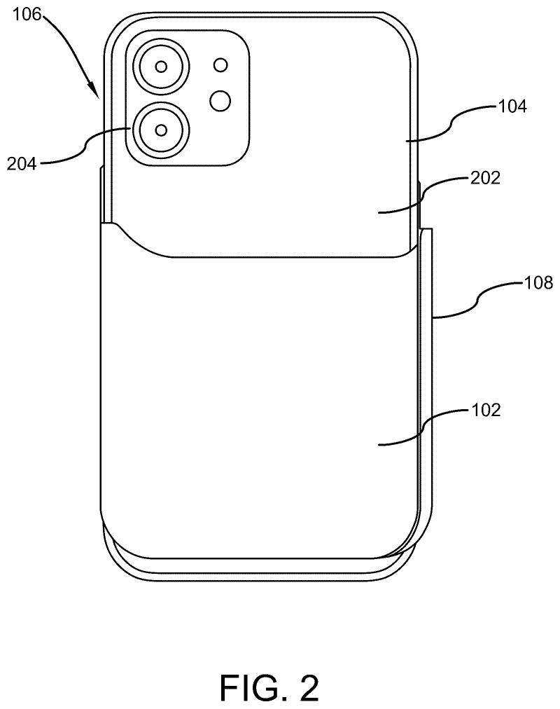

FIG. 2 shows a rear perspective view of the smartphone partially encased within the main body of the private call privacy case of the present invention in accordance with the disclosed structure. The main case body 102 positions snugly around the rear panel 202 of the smartphone 104 such that the upper rear region or camera area 204 of the smartphone 104 is exposed for function and ventilation. The main case body 102 also offers shock protection and mechanical support for additional attachments and is thin enough to preserve the original profile of the smartphone 104. The privacy case 100 is designed to be slip-fit or snap-fit along the lateral edges of the smartphone 104 for firm but removable installation. The privacy or audio barrier 106 (FIG. 1) extends laterally from the lateral end 108 of the main case body 102, wherein the lateral end 108 is also configured to accommodate the privacy or audio barrier 106 in the collapsed or non-deployed position.

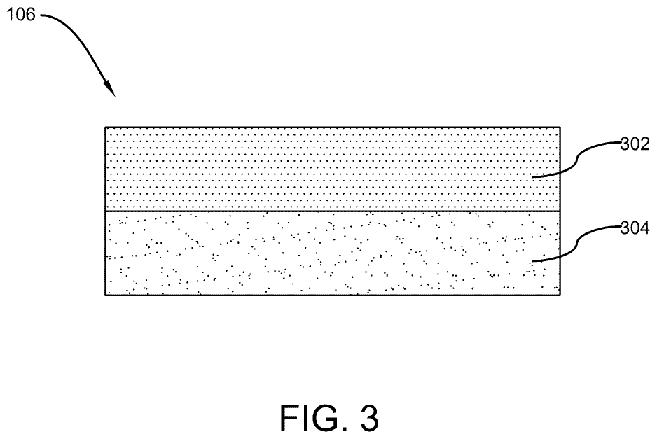

FIG. 3 illustrates a cross-sectional view of the privacy or audio barrier used in the privacy phone case device of FIG. 1 in accordance with the disclosed structure. The privacy or audio barrier 106 is a multilayer structure and includes an outer shell 302 made of rubberized plastic or carbon fiber-textured polymer. The outer shell 302 provides accordion structure to the privacy or audio barrier 106 and a sturdy structure for maintaining the shape in the extended configuration (i.e., deployed position).

An inner shell 304 of acoustic foam or neoprene is adhered or affixed to the outer shell 302 and is designed to absorb and dampen the voice of the user using the privacy phone case device 100. It should be noted that the privacy or audio barrier 106 blocks ambient noise from reaching the speaker (user using the phone case device 100), thereby improving incoming sound clarity.

FIG. 4 illustrates a perspective view of the privacy phone case with the privacy or audio barrier in the extended configuration (i.e., deployed position) during use in accordance with the disclosed structure. In the extended position, the accordion-style barrier 106 unfolds from the lateral side 108 of the main case body 102 and is designed to curve around the speaker's mouth and partially shield the microphone area of the smartphone 104. The barrier 106 is adapted to muffle the user's voice, reduce sound leakage or sound bleed, and improve privacy during calls.

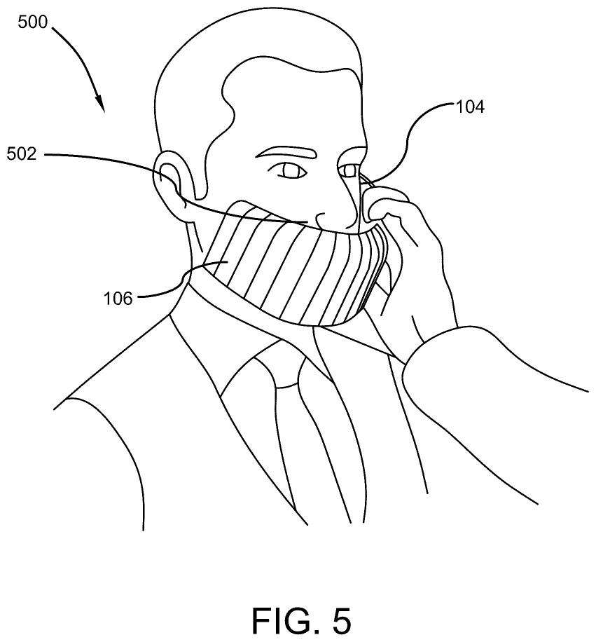

FIG. 5 illustrates a perspective view of a user engaged in a phone call while using the privacy mask device of FIG. 1 in accordance with the disclosed structure. The user 500 operates the phone 104 in conjunction with privacy device 100 to maintain discretion and privacy. The privacy or audio barrier 106 remains in the extended configuration (i.e., deployed position) and is positioned over the mouth 502 of the user 500. The privacy or audio barrier 106 is designed to be lightweight, extendable, and comfortable for prolonged use and is structured to enable clear speech transmission to the phone microphone while minimizing external audibility.

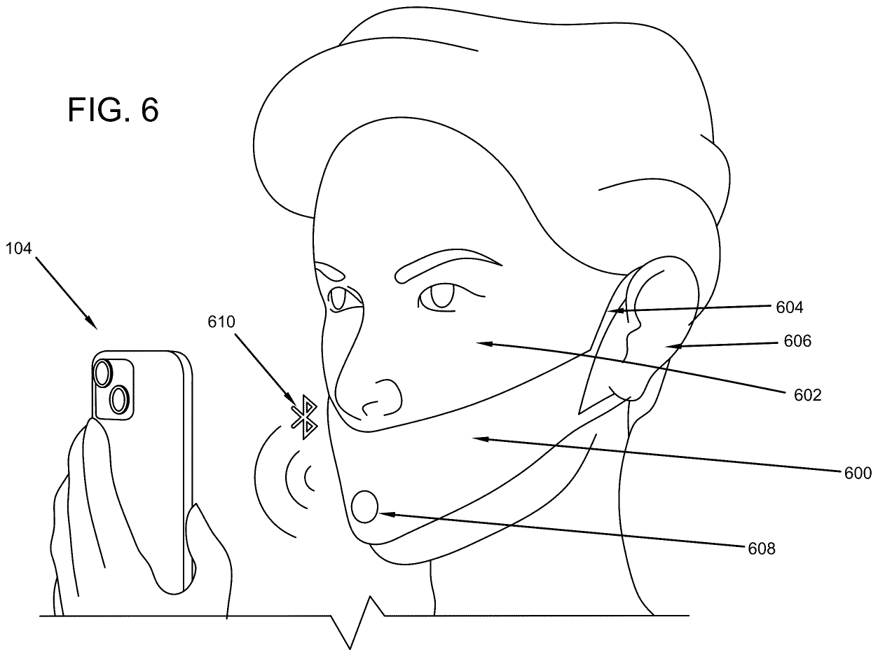

FIG. 6 illustrates a user wearing another embodiment of the privacy device of the present invention in the form of a wireless privacy mask in accordance with the disclosed structure. In the present embodiment, the privacy mask device 600 is configured to be positioned over the mouth region 602 of a wearer and is held in place by one or more support straps 604 extending around the ears 606 of the wearer. The privacy mask 600 is ergonomically shaped to conform to the lower face and jawline of the user. The body of the privacy mask device 600 may be formed of flexible, sound-attenuating materials, such as laminated acoustic foam, silicone rubber, or other sound-insulating composites. The internal cavity of the mask 600 may contain a microphone 608 configured to capture the speech (i.e., audio) of the user while minimizing leakage of sound to the external environment.

The mask device 600 is operatively paired with the mobile device 104 via a wireless communication protocol 610, such as Bluetooth, Wi-Fi, or other low-energy communication standards. The wireless communication enables voice data to be transmitted from the mask 600 to the phone 104 without requiring physical connection or proximity to the ear of the user. As illustrated, the mobile device 104 may be held at a distance from the user, enabling for hygienic and hands-free operation.

In some embodiments, the privacy mask device 600 may be configured as a reusable and rechargeable wearable device, further improving portability of the device 600. The support straps 604 may be adjustable or removable, and the mask may include a replaceable filter or lining to ensure hygiene during extended use.

The mask device 600 is suited for use in public or shared spaces for preventing the overhearing of private voice communications. The mask 600 not only muffles the voice of the user but also isolates speech capture to prevent ambient noise interference.

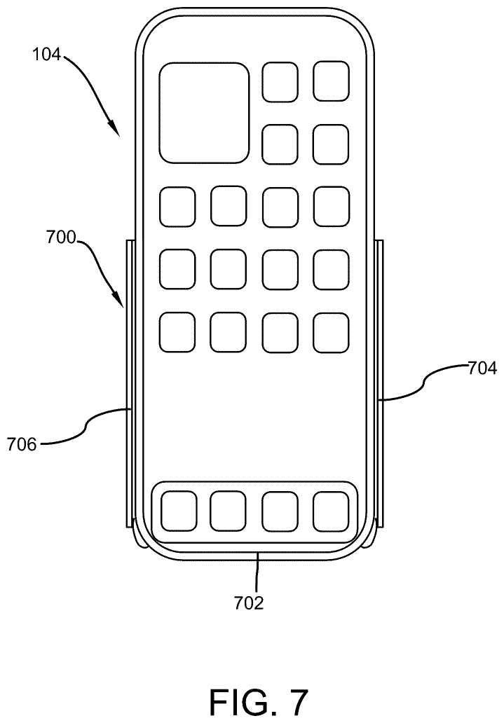

FIG. 7 illustrates a front view of the smartphone fitted with another embodiment of the privacy device in the form of a selectively detachable latch-on case device in accordance with the disclosed structure. In this embodiment, the case device 700 attaches directly onto the lower 702 and side edges 704, 706 of the mobile device 104. The device 700 is engineered to latch onto the body of the phone without interfering with the screen, ports, or buttons.

The latch-on case 700 features a compact profile that is easily removable or re-attachable by the user, enabling the accessory to be stored conveniently when not in use. In some embodiments, the privacy case may include fold-out or snap-on acoustic shells (not shown) that, when deployed, extend around the mouth region of the user to create a temporary acoustic barrier.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “privacy phone case system”, “privacy case for smartphones”, “privacy phone case device”, “wearable privacy device”, and “device” are interchangeable and refer to the privacy phone case device 100, 600, 700 of the present invention.

Notwithstanding the forgoing, the privacy phone case device 100, 600, 700 of the present invention can be of any suitable configuration as is known in the art without affecting the overall concept of the invention, provided that it accomplishes the above stated objectives. One of ordinary skill in the art will appreciate that the privacy phone case device 100, 600, 700 as shown in the FIGS. are for illustrative purposes only, and that many other configurations of the privacy phone case device 100, 600, 700 are well within the scope of the present disclosure. Although the dimensions of the privacy phone case device 100, 600, 700 are important design parameters for user convenience, the privacy phone case device 100, 600, 700 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A privacy phone case device comprising:
a main case body; and
an audio barrier;
wherein said main case body comprises an outer shell and an inner shell;
wherein said main case body is removably affixed to a rear surface of the smartphone and comprises said audio barrier;
wherein said audio barrier selectively extendable in a deployed position and selectively retractable in a non-deployed position;
wherein said audio barrier in said non-deployed position comprises a retracted said audio barrier and a partial encasement of a rear surface and physical protection of the smartphone; and
further wherein said audio barrier in said deployed position covers the mouth area of a user and a microphone pickup zone thereby muffling the user's voice.

2. The privacy phone case device of claim 1, wherein said partial encasement of said rear surface is below a camera area of the smartphone.

3. The privacy phone case device of claim 1, wherein said removably affixed to said rear surface is selected from the group consisting of a slip-fit and a snap-fit along at least one lateral edge of the smartphone for removable installation of said main case body to the smartphone.

4. The privacy phone case device of claim 1, wherein said audio barrier extends laterally from a lateral end of said main case body.

5. The privacy phone case device of claim 1, wherein said outer shell is a rigid outer shell having a material selected from the group consisting of a rubberized plastic and a carbon fiber-textured polymer.

6. The privacy phone case device of claim 1, wherein said audio barrier comprises an accordion-style extension barrier to selectively unfold and fold laterally from at least one lateral end of said main case body.

7. The privacy phone case device of claim 1, wherein said audio barrier in said deployed position comprises a curved, semi-cylindrical acoustic chamber around the user's face from ear to mouth.

8. The privacy phone case device of claim 1, wherein said main case body comprises a rectilinear shape to align with outer dimensions of the smartphone.

9. The privacy phone case device of claim 5, wherein said inner shell having a material selected from the group consisting of an acoustic foam and a neoprene.

10. The privacy phone case device of claim 9, wherein said inner shell is adhered to said outer shell.

11. A privacy phone case device comprising:
a main case body; and
an audio barrier;
wherein said main case body comprises an outer shell and an inner shell;
wherein said main case body is removably affixed to a rear surface of the smartphone and comprises said audio barrier;
wherein said audio barrier selectively extendable in a deployed position and selectively retractable in a non-deployed position;
wherein said audio barrier in said non-deployed position comprises a retracted said audio barrier and a partial encasement of a rear surface and physical protection of the smartphone;
wherein said audio barrier in said deployed position covers the mouth area of a user and a microphone pickup zone thereby muffling the user's voice;
wherein said audio barrier comprises an accordion-style extension barrier to selectively unfold and fold laterally from at least one lateral end of said main case body; and
further wherein said audio barrier in said deployed position comprises a curved, semi-cylindrical acoustic chamber around the user's face from ear to mouth.

12. The privacy phone case device of claim 11, wherein said partial encasement of said rear surface is below a camera area of the smartphone.

13. The privacy phone case device of claim 11, wherein said removably affixed to said rear surface is selected from the group consisting of a slip-fit and a snap-fit along at least one lateral edge of the smartphone for removable installation of said main case body to the smartphone.

14. The privacy phone case device of claim 11, wherein said audio barrier extends laterally from a lateral end of said main case body.

15. The privacy phone case device of claim 11, wherein said outer shell a rigid outer shell having a material selected from the group consisting of a rubberized plastic and a carbon fiber-textured polymer.

16. The privacy phone case device of claim 11, wherein said main case body comprises a rectilinear shape to align with outer dimensions of the smartphone.

17. The privacy phone case device of claim 15, wherein said inner shell having a material selected from the group consisting of an acoustic foam and a neoprene.

18. A privacy phone device comprising:
a wireless privacy mask;
a mobile device; and
a wireless communication protocol;
wherein said wireless privacy mask is configured to be positioned over a mouth region of a wearer;
wherein said wireless privacy mask comprises at least one strap extending around an ear of the user;
wherein said wireless privacy mask is ergonomically shaped to conform to a lower face and jawline of the wearer;
wherein said wireless privacy mask having a flexible material selected from the group consisting of a laminated acoustic foam, a silicone rubber, and a sound-insulating composite; and
further wherein said wireless privacy mask comprises an internal cavity having a microphone configured to capture the audio of the wearer.

19. The privacy phone device of claim 18, wherein said wireless privacy mask is operatively paired with said mobile device with said wireless communication protocol selected from the group consisting of Bluetooth, Wi-Fi, and low-energy communication standard.

20. The privacy phone device of claim 19, wherein said wireless privacy mask is a rechargeable wearable device.
